(19) United States
(12) Patent Application Publication
(10) Pub. No.: US 2023/0227014 A1
(43) Pub. Date: Jul. 20, 2023

(54) BRAKE DEVICE

(71) Applicant: SUBARU CORPORATIOLN, Tokyo (JP)

(72) Inventor: Yusuke ANDO, Tokyo (JP)

(21) Appl. No.: 18/077,663

(22) Filed: Dec. 8, 2022

(30) Foreign Application Priority Data
Jan. 14, 2022 (JP) 2022-004296

(51) Int. Cl. B60T 11/224; B60T 11/236

(52) U.S. Cl. CPC B60T 11/224; B60T 11/236

(57) ABSTRACT

A brake device includes a master cylinder, a braking mechanism for braking a wheel of a vehicle, a hydraulic pressure circuit coupling the master cylinder to the braking mechanism, and a reservoir tank storing a hydraulic fluid of the master cylinder. The master cylinder includes a housing, a piston, and a seal member. The piston changes a hydraulic pressure of the hydraulic fluid in a hydraulic pressure chamber in the housing. The seal member is moved with the piston to seal a gap between the housing and the piston. First to third positions are positioned in sequence in a moving direction of the piston. A replenishing hole of the housing communicates with the hydraulic pressure chamber when the piston is at the first position. The seal member closes the replenishing hole when the piston is at the second position. The hydraulic pressure of the hydraulic fluid is made negative with the seal member closing the replenishing hole when the piston is at the third position.

### CROSS-REFERENCE TO RELATED APPLICATIONS

The present application claims priority from Japanese Patent Application No. 2022-004296 filed on Jan. 14, 2022, the entire contents of which are hereby incorporated by reference.

### BACKGROUND

The disclosure relates to a brake device mounted in a vehicle such as a motor vehicle.

As a brake device mounted in a vehicle, a hydraulic brake device using a hydraulic pressure of a hydraulic fluid has been known. In the hydraulic brake device, a pedal force of a brake pedal is transformed into a hydraulic pressure in a master cylinder, and the hydraulic pressure transmitted via a hydraulic pressure circuit is transformed into a braking force in a braking mechanism to brake each wheel. In such a hydraulic brake device, a mixture of air (air bubbles) into the hydraulic fluid may reduce brake performance or cause the brake device to malfunction. To address the issues, some hydraulic brake devices include a bleeding mechanism for bleeding the generated air (refer to, for example, Japanese Unexamined Patent Application Publication (JP-A) No. 2010-208393).

### SUMMARY

An aspect of the disclosure provides a brake device including a master cylinder, a braking mechanism, a hydraulic pressure circuit, and a reservoir tank. The braking mechanism is configured to brake a wheel of a vehicle by a braking force. The hydraulic pressure circuit couples the master cylinder to the braking mechanism. The reservoir tank is configured to store a hydraulic fluid of the master cylinder. The master cylinder includes a housing, a piston, and a seal member. The housing has an interior space and a replenishing hole. The interior space serves as a hydraulic pressure chamber. The replenishing hole communicates with the reservoir tank. The piston is configured to change a hydraulic pressure of the hydraulic fluid in the hydraulic pressure chamber by being moved with respect to the housing. The seal member is configured to seal a gap between the housing and the piston by being moved along with the piston. A first position, a second position, and a third position are positioned side by side in sequence as moving positions of the piston in a moving direction of the piston. The replenishing hole communicates with the hydraulic pressure chamber when the piston is at the first position. The seal member closes the replenishing hole when the piston is at the second position. The hydraulic pressure of the hydraulic fluid in the hydraulic pressure chamber is made a negative pressure in a state in which the seal member closes the replenishing hole when the piston is at the third position.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to describe the principles of the disclosure.

FIG. 1 illustrates embodiments of a brake device along with FIGS. 2 to 7 and is a schematic configuration diagram of the brake device.

FIG. 2 is a cross-sectional view of a master cylinder illustrating a state of moving a piston to a first position.

FIG. 3 is a cross-sectional view of the master cylinder illustrating a state of moving the piston to a second position.

FIG. 4 is a cross-sectional view of the master cylinder illustrating a halfway state of moving the piston from the second position to a third position.

FIG. 5 is a cross-sectional view of the master cylinder illustrating a state of moving the piston to the third position.

FIG. 6 is a cross-sectional view illustrating a state in which a second end of a seal member contacts an opening edge of a replenishing hole.

FIG. 7 is a cross-sectional view illustrating a state in which the seal member elastically deforms, and air flows to a reservoir tank.

### DETAILED DESCRIPTION

In general, air bleeding is performed in the brake device by the following method. While a bleeder (air bleeding valve) provided in a braking mechanism is opened, a hydraulic pressure of a hydraulic fluid stored in a master cylinder is increased so that the air, as well as the hydraulic fluid, is ejected from the bleeder.

Meanwhile, with recent advances in the brake device, shapes of a hydraulic pressure circuit and the braking mechanism are increasingly complicated. The air tends to stagnate in complex members in the complicated hydraulic pressure circuit and braking mechanism. This may result in insufficient air bleeding from the brake device with the air bleeding method described above.

On the other hand, another known air bleeding method (so-called vacuuming) is coupling a vacuum pump to a reservoir tank communicating with the master cylinder, putting the reservoir tank under negative pressure, and attracting the air toward the master cylinder in a brake device. With this method, the air is allowed to flow in an opposite direction to that in the ordinary air bleeding method, making it difficult for the air to stagnate in the brake device. However, this method involves large-scale external machinery, lots of time and labor, and the like, and is challenging to implement in phases other than a manufacturing phase.

Therefore, it is desirable to bleed sufficient air from a brake device and ensure a good operation state with simple configurations.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Schematic Configurations of Brake Device

Schematic configurations of a brake device will first be described.

A vehicle 100 includes a brake device 1.

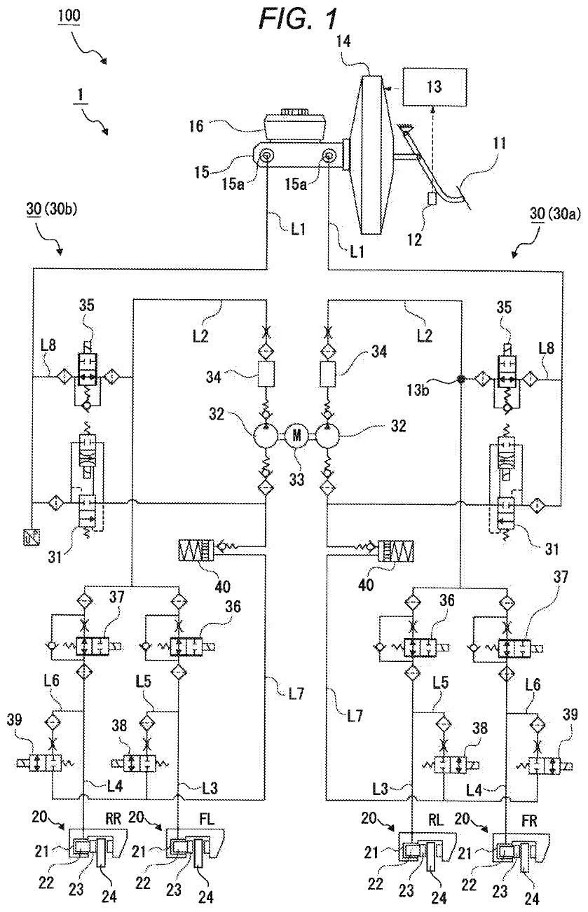

The brake device 1 has a brake pedal 11, a brake sensor 12, a controller 13, a brake booster (toggle) 14, a master cylinder 15, a reservoir tank 16, multiple braking mechanisms 20, and multiple hydraulic pressure circuits 30 (refer to FIG. 1).

The brake pedal 11 is coupled to the brake booster 14. The brake sensor 12 detects a pedal force (depression amount) of the brake pedal 11 and outputs information indicating the detected pedal force to the controller 13.

Examples of the controller 13 include a processor that includes a central processing unit (CPU), a read only memory (ROM), and a random access memory (RAM). The controller 13 controls the brake booster 14 on the basis of the information from the brake sensor 12. The controller 13 also controls the overall brake device 1 including valves and the like to be described later in each hydraulic pressure circuit 30 on the basis of information from a predetermined sensor, not illustrated. The controller 13 exercises hydraulic pressure control such as an antilock braking system (ABS) control and an electronic stability program (ESP) control.

The brake booster 14 is, for example, an electric brake booster and moves two pistons, to be described later, of the master cylinder 15 under the control of the controller 13. The brake booster 14 imparts a driving force responsive to, for example, the pedal force of the brake pedal 11 to each piston.

The master cylinder 15 is, for example, a tandem master cylinder with the above-described two pistons moved under the control of the controller 13. The master cylinder 15 operates under the control of the controller 13. The master cylinder 15, which is coupled to the reservoir tank 16 storing a hydraulic fluid, transforms the pedal force of the brake pedal 11 into a hydraulic pressure of the hydraulic fluid. The master cylinder 15 has feeding/discharging ports 15a, 15a coupled to the hydraulic pressure circuit 30. The master cylinder 15 is coupled to the multiple braking mechanisms 20 via the hydraulic pressure circuit 30.

The reservoir tank 16 stores the hydraulic fluid at atmospheric pressure.

Four braking mechanisms 20, for example, are provided, are implemented as disc braking mechanisms, and are provided in a right front wheel FR, a left front wheel FL, a right rear wheel RR, and a left rear wheel RL, respectively. The braking mechanisms 20 each include a brake caliper 21, a brake piston 22, a brake pad 23, and a brake rotor 24.

The brake piston 22 is movably supported on the brake caliper 21. A hydraulic pressure is transmitted to the brake caliper 21 from the master cylinder 15 via the hydraulic pressure circuit 30. The brake piston 22 is moved relative to the brake caliper 21 by the transmitted hydraulic pressure.

The brake pad 23 is coupled to a tip end of the brake piston 22 and pressed against the brake rotor 24 rotating, along with the wheel, when the brake piston 22 is moved by the hydraulic pressure. Each braking mechanism 20 thereby brakes the vehicle 100 (a respective one of the wheels).

The hydraulic pressure circuit 30 includes, for example, two systems of a first circuit 30a and a second circuit 30b. For example, the hydraulic pressure circuits 30 correspond to cross pipes. For example, the first circuit 30a is coupled to the braking mechanisms 20, 20 provided at the right front wheel FR and the left rear wheel RL, and the second circuit 30b is coupled to the braking mechanisms 20, 20 provided at the left front wheel FL and the right rear wheel RR.

The first circuit 30a and the second circuit 30b are identical in configurations. Therefore, the first circuit 30a and the second circuit 30b will be described simply hereinafter while the same reference signs denote identical elements. In addition, the hydraulic pressure circuit 30 will be described on the assumption that a master cylinder 15-side is upstream and a braking mechanism 20-side is downstream.

Each of the first circuit 30a and the second circuit 30b has a first hydraulic line L1, a second hydraulic line L2, a third hydraulic line L3, a fourth hydraulic line L4, a fifth hydraulic line L5, a sixth hydraulic line L6, a seventh hydraulic line L7, and an eighth hydraulic line L8.

An upstream end of the first hydraulic line L1 is coupled to the feeding/discharging port 15a of the master cylinder 15, and a downstream end is coupled to the second hydraulic line L2. A gate-in valve 31 is provided in the first hydraulic line L1.

A hydraulic pressure pump 32 is provided in the second hydraulic line L2. The hydraulic pressure pump 32 provided in the first circuit 30a and the hydraulic pressure pump 32 provided in the second circuit 30b are coupled to a common electric motor 33. A pulsation pressure reduction mechanism 34 that attenuates pulsation of a hydraulic fluid delivered from the hydraulic pressure pump 32 is provided in the second hydraulic line L2 downstream of the hydraulic pressure pump 32. A downstream end of the second hydraulic line L2 is branched into and coupled to the third hydraulic line L3 and the fourth hydraulic line L4. The first hydraulic line L1 and the second hydraulic line L2 are provided as common hydraulic lines.

A pressure valve 36 is provided in the third hydraulic line L3. A downstream end of the third hydraulic line L3 is coupled to the braking mechanism 20 of the left front wheel FL or the left rear wheel RL. An upstream end of the fifth hydraulic line L5 is coupled to the third hydraulic line L3 downstream of the pressure valve 36.

A pressure valve 37 is provided in the fourth hydraulic line L4. A downstream end of the fourth hydraulic line L4 is coupled to the braking mechanism 20 of the right front wheel FR or the right rear wheel RR. An upstream end of the sixth hydraulic line L6 is coupled to the fourth hydraulic line L4 downstream of the pressure valve 37.

The third hydraulic line L3 and the fourth hydraulic line L4 are each provided as a wheel-specific hydraulic line coupled to the corresponding braking mechanism 20.

A pressure reducing valve 38 is provided in the fifth hydraulic line L5. A pressure reducing valve 39 is provided in the sixth hydraulic line L6. The seventh hydraulic line L7 is coupled to downstream ends of the fifth hydraulic line L5 and the sixth hydraulic line L6.

A low-pressure chamber 40 that temporarily stores the hydraulic fluid is provided in the seventh hydraulic line L7. A downstream end of the seventh hydraulic line L7 is coupled to a downstream end of the first hydraulic line L1.

The eighth hydraulic line L8 bypasses an upstream side of the gate-in valve 31 in the first hydraulic line L1 to a downstream side of the pulsation pressure reduction mechanism 34 in the second hydraulic line L2. A bypass valve 35 is provided in the eighth hydraulic line L8.

The gate-in valve 31, the electric motor 33, the bypass valve 35, the pressure valve 36, the pressure valve 37, the pressure reducing valve 38, and the pressure reducing valve 39 are controlled by the controller 13, independently.

For example, an electromagnetic valve closed at non-energized times (non-controlled times) and opened at energized times (controlled times) is used as each of the gate-in valve 31, the pressure reducing valve 38, and the pressure reducing valve 39. For example, an electromagnetic valve opened at non-energized times (non-controlled times) and closed at energized times (controlled times) is used as each of the bypass valve 35, the pressure valve 36, and the pressure valve 37.

In a state in which the controller 13 does not exercise hydraulic pressure control, such as the ABS control and the ESP control, the gate-in valve 31, the pressure reducing valve 38, and the pressure reducing valve 39 are closed, and the bypass valve 35, the pressure valve 36, and the pressure valve 37 are opened, as described above. In addition, the electric motor 33 is not driven and each hydraulic pressure pump 32 is stopped.

When a driver who drives the vehicle 100 depresses the brake pedal 11 in the state in which the controller 13 does not exercise the hydraulic pressure control such as the ABS control, the pedal force of the brake pedal 11 is transformed into the hydraulic pressure in the master cylinder 15. The resultant hydraulic pressure, which passes through the first hydraulic line L1, the eighth hydraulic line L8, and the second hydraulic line L2, is branched into the third hydraulic line L3 and the fourth hydraulic line L4 and transmitted to the braking mechanisms 20. The transmitted hydraulic pressure helps the braking mechanisms 20 brake the wheels (left front wheel FL, the right front wheel FR, the left rear wheel RL, and the right rear wheel RR).

On the other hand, at times of the hydraulic pressure control, such as the ABS control and the ESP control, the controller 13 controls each gate-in valve 31 into an opened state and each bypass valve 35 into a closed state. Through this control, the gate-in valve 31, the pressure valve 36, and the pressure valve 37 turn into an opened state, and the bypass valve 35, the pressure reducing valve 38, and the pressure reducing valve 39 turn into a closed state. Furthermore, the controller 13 drives the electric motor 33 during the hydraulic pressure control, such as the ABS control and the ESP control.

Through the above control, the electric motor 33 is driven to rotate each hydraulic pressure pump 32. The hydraulic fluid stored in the reservoir tank 16 is suctioned into the first hydraulic line L1 via the master cylinder 15 independently of an operation on the brake pedal 11. The hydraulic fluid suctioned into the first hydraulic line L1, which passes through the second hydraulic line L2 via the gate-in valve 31, is branched into the third hydraulic line L3 and the fourth hydraulic line L4 and transmitted to each braking mechanism 20. The hydraulic pressure of the transmitted hydraulic fluid allows each braking mechanism 20 to brake the respective one of the wheels.

Furthermore, when reducing the hydraulic pressure transmitted to the braking mechanism 20, such as temporarily damping a braking force under the ABS control, the controller 13 controls the bypass valve 35, the pressure valve 36, and the pressure valve 37 into a closed state, and controls the pressure reducing valve 38 and the pressure reducing valve 39 into an opened state. At this time, the controller 13 keeps the gate-in valve 31 in the opened state. Through this control, the gate-in valve 31, the pressure reducing valve 38, and the pressure reducing valve 39 turn into the opened state, and the bypass valve 35, the pressure valve 36, and the pressure valve 37 turn into the closed state. In addition, the controller 13 continues to drive the electric motor 33.

In this case, the electric motor 33 is driven to rotate the hydraulic pressure pump 32. As a result, the hydraulic fluid in the braking mechanisms 20 (brake calipers 21) passes from the third hydraulic line L3 and the fourth hydraulic line L4 through the fifth hydraulic line L5 and the sixth hydraulic line L6, respectively, and flows into the seventh hydraulic line L7. The hydraulic fluid flowing into the seventh hydraulic line L7 is stored in the low-pressure chamber 40. As a result, the hydraulic pressure of the hydraulic fluid in each braking mechanism 20 is reduced to mitigate the brake on the wheel by the braking mechanism 20.

### Configurations of Master Cylinder

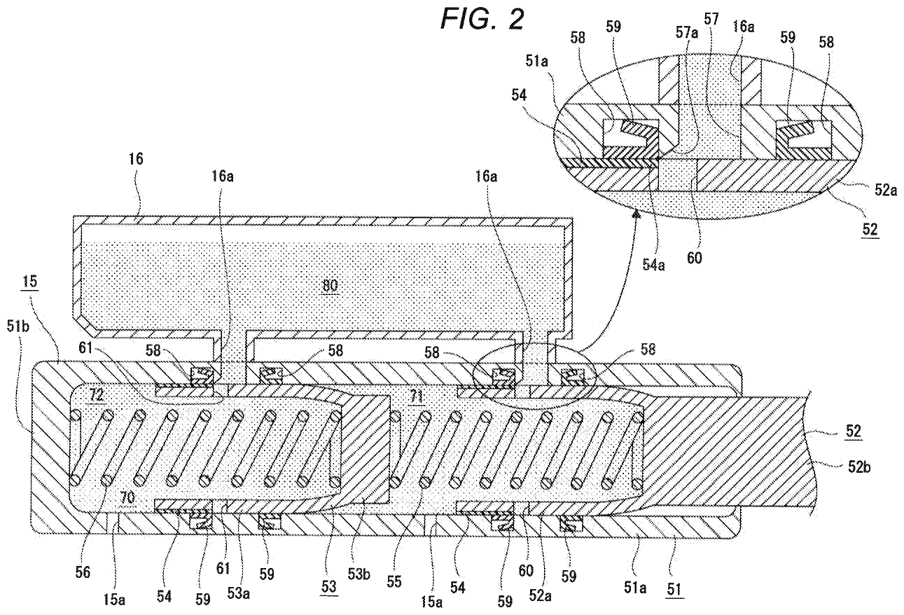

Configurations of the master cylinder 15 will next be described (refer to FIG. 2).

As described above, the master cylinder 15 includes the pistons. In the following descriptions, longitudinal and transverse directions are indicated in the master cylinder 15, while it is assumed that a piston moving direction is the longitudinal direction and a brake booster 14-side is rearward. It is to be noted that the longitudinal and transverse directions are indicated below for the sake of convenience and that directions are not limited to these directions in implementing the disclosure.

The master cylinder 15 has a housing 51, a primary piston 52, a secondary piston 53, seal members 54, 54, a first coil spring 55, and a second coil spring 56.

The housing 51 has a cylindrical peripheral surface 51a having an axial direction set to the longitudinal direction and a front surface 51b closing a front opening of the peripheral surface 51a. The peripheral surface 51a has replenishing holes 57, 57 apart in the longitudinal direction. The reservoir tank 16 is attached to the master cylinder 15, and the replenishing holes 57, 57 communicate with replenishing hydraulic lines 16a, 16a of the reservoir tank 16, respectively. The hydraulic fluid is supplied from the reservoir tank 16 to an interior space 70 of the housing 51 via the replenishing holes 57, 57. In each replenishing hole 57, a front end of an opening edge on an inner periphery of the housing 51 is located forward of a front end of an opening edge on an outer periphery of the housing 51. A front edge of the opening edge on the inner periphery is an inclination 57a that deforms forward from the outer peripheral side to the inner peripheral side of the peripheral surface 51a.

The peripheral surface 51a has the feeding/discharging ports 15a, 15a apart longitudinally, and the first circuit 30a and the second circuit 30b are coupled to the feeding/discharging ports 15a, 15a, respectively. The whole of the primary piston 52 except for a rear end part and the whole of the secondary piston 53 are located in the interior space 70. The primary piston 52 and the secondary piston 53 are disposed side by side in such a manner as to be movable with respect to the housing 51 in the longitudinal direction.

Multiple annular disposed recesses 58 are formed in an inner periphery of the peripheral surface 51a. The disposed recesses 58 are formed on two longitudinal sides of each replenishing hole 57. An annular cup seal 59 is disposed in each disposed recess 58. The cup seal 59 is formed from, for example, a rubber material. The cup seal 59 can slide on the primary piston 52, the secondary piston 53, or each seal member 54.

The primary piston 52 has a generally cylindrical slider 52a and a columnar shaft 52b continuous to a rear end of the slider 52a. In the primary piston 52, an outer diameter of the shaft 52b is set smaller than an outer diameter of the slider 52a. During movement in the longitudinal direction, the slider 52a slides on at least one of the cup seals 59 disposed in front of and in the rear of the replenishing hole 57. Multiple flowing holes 60 penetrating an inner peripheral surface and an outer peripheral surface of the slider 52a are formed in the slider 52a to be apart in a circumferential direction. The primary piston 52 is disposed with a rear end part of the shaft 52b protruding rearward from the housing 51.

The annular seal member 54 is attached to the outer peripheral surface of a front end of the slider 52a. The seal member 54 is formed from, for example, a rubber material. A rear end of the seal member 54 is provided as a first end 54a and a front end is provided as a second end 54b. The whole of the seal member 54, except for the second end 54b, is bonded to the outer peripheral surface of the slider 52a. Therefore, the second end 54b is not bonded to an outer peripheral surface of the primary piston 52 and is closely attached to the outer peripheral surface of the primary piston 52 by an elastic force of the seal member 54. The seal member 54 is moved, along with the primary piston 52, with respect to the housing 51 while sealing a gap between an inner peripheral surface of the housing 51 and the outer peripheral surface of the primary piston 52.

The secondary piston 53 has a generally cylindrical slider 53a and a columnar shaft 53b continuous to a rear end of the slider 53a. In the secondary piston 53, an outer diameter of the shaft 53b is set smaller than an outer diameter of the slider 53a. During movement in the longitudinal direction, the slider 53a slides on at least one of the cup seals 59 disposed in front of and in the rear of the replenishing hole 57. Multiple flowing holes 61 penetrating an inner peripheral surface and an outer peripheral surface of the slider 53a are formed in the slider 53a to be apart in the circumferential direction. The shaft 53b of the secondary piston 53 is shorter than the shaft 52b of the primary piston 52 in the longitudinal direction, and the secondary piston 53 is disposed in front of the primary piston 52.

The annular seal member 54 is attached to the outer peripheral surface of a front end of the slider 53a. The seal member 54 is formed from, for example, a rubber material. A rear end of the seal member 54 is provided as a first end 54a and a front end is provided as a second end 54b. The whole of the seal member 54, except for the second end 54b, is bonded to the outer peripheral surface of the slider 53a. Therefore, the second end 54b is not bonded to an outer peripheral surface of the secondary piston 53 and is closely attached to the outer peripheral surface of the secondary piston 53 by the elastic force of the seal member 54. The seal member 54 is moved, along with the secondary piston 53, with respect to the housing 51 while sealing a gap between the inner peripheral surface of the housing 51 and the outer peripheral surface of the secondary piston 53.

Both ends of the first coil spring 55 contact a front surface of the shaft 52b of the primary piston 52 and a rear surface of the shaft 53b of the secondary piston 53, respectively. Both ends of the second coil spring 56 contact a front surface of the shaft 53b of the secondary piston 53 and a rear surface of the front surface 51b of the housing 51, respectively.

In the interior space 70 of the housing 51, a part surrounded by the inner peripheral surface of the housing 51, the primary piston 52, and the secondary piston 53 serve as a first hydraulic pressure chamber 71, and a part surrounded by the inner peripheral surface and the front surface 51b of the housing 51 and the secondary piston 53 serve as a second hydraulic pressure chamber 72. In the master cylinder 15, spring forces of the first coil spring 55 and the second coil spring 56 are adjusted so that the hydraulic pressure of the hydraulic fluid in the first hydraulic pressure chamber 71 is equal to the hydraulic pressure of the hydraulic fluid in the second hydraulic pressure chamber 72.

The primary piston 52 is moved with respect to the housing 51 in the longitudinal direction under the control of the controller 13. The secondary piston 53 follows the primary piston 52 to be moved with respect to the housing 51 by a distance identical to a distance of the primary piston 52 in the same direction. Moving the primary piston 52 and the secondary piston 53 allows changes in the hydraulic pressures of the hydraulic fluids in the first hydraulic pressure chamber 71 and the second hydraulic pressure chamber 72.

### Piston Moving Positions

Moving positions of the primary piston 52 and the secondary piston 53 with respect to the housing 51 in the master cylinder 15 will next be described (refer to FIGS. 2 to 5).

In the master cylinder 15, a first position, a second position, and a third position are set as the moving positions of each of the primary piston 52 and the secondary piston 53 with respect to the housing 51 to correspond to a positional relationship with the replenishing hole 57. It is to be noted, however, that a position of the primary piston 52 relative to the rear replenishing hole 57 is set identical to that of the secondary piston 53 relative to the front replenishing hole 57. Therefore, the moving position of the primary piston 52 with respect to the housing 51 will be described below, and the moving position of the secondary piston 53 with respect to the housing 51 will not be described.

The first position is where the first hydraulic pressure chamber 71 communicates with the replenishing hole 57 via the flowing hole 60 (refer to FIG. 2). In a state in which the primary piston 52 is moved to the first position, the hydraulic pressure of the hydraulic fluid in the first hydraulic pressure chamber 71 is set equal to the atmospheric pressure.

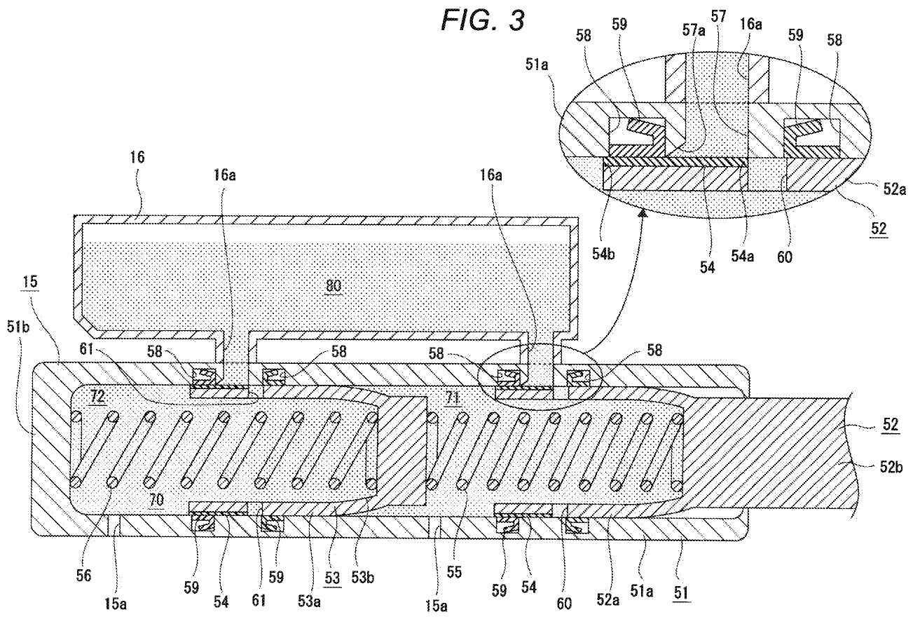

The second position is where the primary piston 52 is moved backward from the first position, and the replenishing hole 57 is closed by the seal member 54 with the first end 54a of the seal member 54 in contact with the opening edge of the replenishing hole 57 (refer to FIG. 3). In a state in which the primary piston 52 is moved to the second position from the first position, the hydraulic pressure of the hydraulic fluid in the first hydraulic pressure chamber 71 is set nearly equal to the atmospheric pressure.

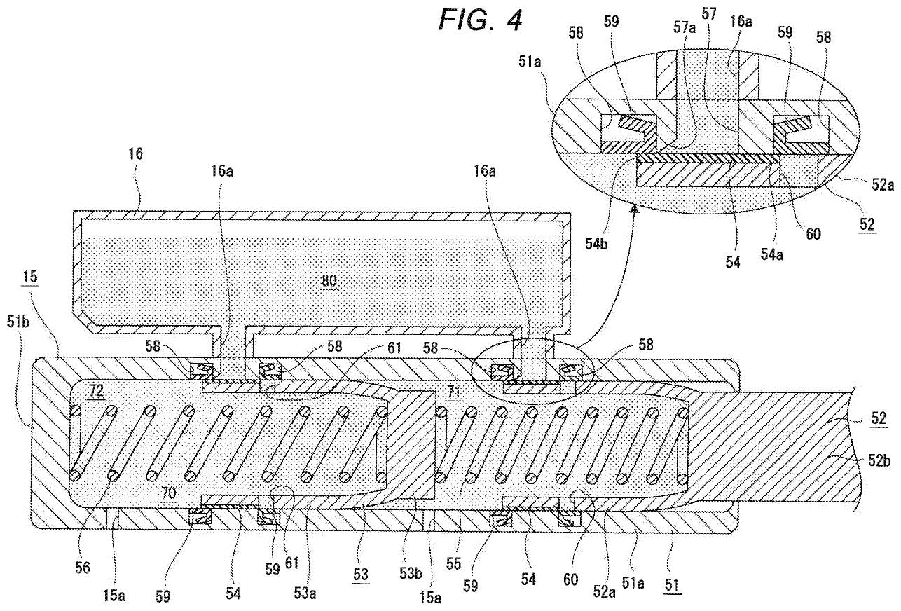

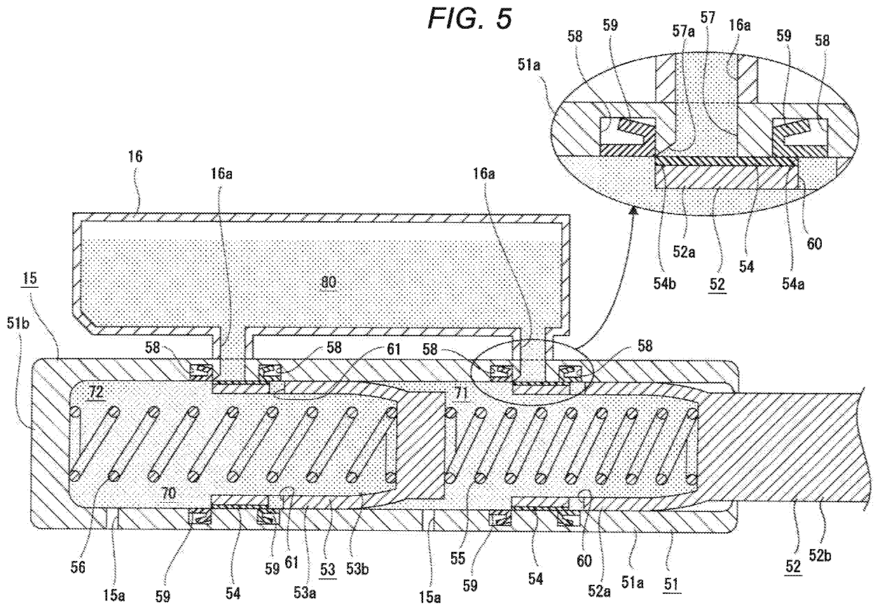

The third position is where the primary piston 52 is moved backward from the second position (refer to FIG. 4), and the replenishing hole 57 is closed by the seal member 54 with the second end 54b of the seal member 54 in contact with the opening edge of the replenishing hole 57 (refer to FIG. 5). Moving the primary piston 52 from the second position to the third position makes the hydraulic pressure of the hydraulic fluid in the first hydraulic pressure chamber 71 a negative pressure.

### Air Bleeding Operation in Brake Device

An air bleeding operation in the brake device 1 will next be described (refer to FIGS. 2 to 7).

A change in the hydraulic pressure in the second hydraulic pressure chamber 72 by the movement of the secondary piston 53 with respect to the housing 51 is the same as that in the hydraulic pressure in the first hydraulic pressure chamber 71 by the movement of the primary piston 52 with respect to the housing 51. Therefore, the air bleeding operation in the brake device 1 in relation to the movement of the primary piston 52 will be mainly described, and the air bleeding operation in the brake device 1 in relation to the movement of the secondary piston 53 will be briefly described.

Furthermore, in the descriptions below, it is assumed that a direction in which the primary piston 52 is moved from the first position to the third position is a first moving direction and that a direction in which the primary piston 52 is moved from the third position to the first position is a second moving direction.

Air bleeding is performed in the brake device 1 while the vehicle 100 is not running. The primary piston 52 is located at the first position while the master cylinder 15 is not controlled by the controller 13 (refer to FIG. 2). In this state, the hydraulic pressure of the hydraulic fluid in the first hydraulic pressure chamber 71 is equal to the atmospheric pressure, and the braking mechanisms 20 do not brake the vehicle 100 (wheels).

From this state, the primary piston 52 is moved to the first direction under the control of the controller 13. In the master cylinder 15, the gap between the primary piston 52 and the housing 51 remains sealed by the seal members 54 and the cup seals 59 even during the movement of the primary piston 52. While the primary piston 52 is being moved from the first position to the second position, a state of communication between the first hydraulic pressure chamber 71 and the reservoir tank 16 is maintained. Therefore, the hydraulic pressure of the hydraulic fluid in the first hydraulic pressure chamber 71 is equal to the atmospheric pressure.

When the primary piston 52 is moved to the second position, the first end 54a of the seal member 54 contacts a rear edge of the opening edge of the replenishing hole 57, and the replenishing hole 57 is closed by the seal member 54 (refer to FIG. 3). While the primary piston 52 is moved to the second position, the hydraulic pressure of the hydraulic fluid in the first hydraulic pressure chamber 71 is kept equal to the atmospheric pressure.

While the primary piston 52 is being moved from the second position to the third position in the first direction, the state in which the replenishing hole 57 is closed by the seal member 54 is maintained (refer to FIG. 4). Therefore, the hydraulic fluid does not flow between an interior space 80 of the reservoir tank 16 and the interior space 70 of the housing 51. As a result, moving the primary piston 52 from the second position to the first direction makes the hydraulic pressure of the hydraulic fluid in the first hydraulic pressure chamber 71 the negative pressure. The hydraulic pressure of the hydraulic fluid in the first hydraulic pressure chamber 71 gradually falls as the primary piston 52 is moved from the second position to the first direction. In the master cylinder 15, therefore, the hydraulic fluid in the first hydraulic pressure chamber 71 has the highest negative pressure in the state in which the primary piston 52 is moved to the third position. In the state in which the primary piston 52 is moved to the third position, the second end 54b of the seal member 54 contacts a front edge of the opening edge of the replenishing hole 57 (refer to FIG. 5).

As described above, when the hydraulic pressure of the hydraulic fluid in the first hydraulic pressure chamber 71 changes from the atmospheric pressure to the negative pressure, the air in the brake device 1 is moved toward the master cylinder 15.

In the air bleeding operation in the brake device 1, the primary piston 52 is desirably moved from the first position to the first direction in a state such as that in which a container or the like storing the hydraulic fluid is coupled to a bleeder, not illustrated, provided in each brake caliper 21 and in which the brake device 1 is replenished with the hydraulic fluid.

In the brake device 1, when the hydraulic pressure of the hydraulic fluid in the first hydraulic pressure chamber 71 is made the negative pressure, the hydraulic pressure of the hydraulic fluid in the second hydraulic pressure chamber 72 is also made the negative pressure. This is because the secondary piston 53 is moved as well as the primary piston 52. Thus, the hydraulic pressure of the entire hydraulic fluid stored in the interior space 70 of the housing 51 is made the negative pressure. Therefore, the hydraulic pressure of the hydraulic fluid in the braking mechanisms 20 is made the negative pressure via the first circuit 30a and the second circuit 30b. At this time, replenishing each braking mechanism 20 with the hydraulic fluid from the container or the like storing the hydraulic fluid via the bleeder facilitates generating a flow of the hydraulic fluid from the braking mechanism 20 to the master cylinder 15 in the brake device 1.

When the hydraulic fluid flows from the braking mechanisms 20 toward the master cylinder 15, the air generated in the braking mechanisms 20 and the hydraulic pressure circuit 30 flows, along with the hydraulic fluid, toward the master cylinder 15. The air flowing, along with the hydraulic fluid, from the braking mechanisms 20 and the hydraulic pressure circuit 30 to the master cylinder 15 is delivered into the interior space 70 of the housing 51 from the feeding/discharging port 15a, 15a.

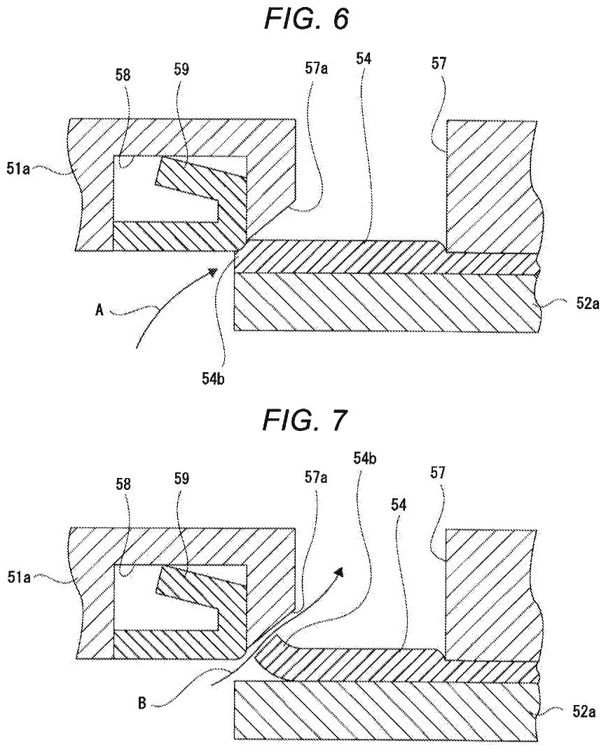

The hydraulic fluid flows into the interior space 70 of the housing 51 at a high flow rate. Therefore, a force acts on the second ends 54b of the seal members 54 in contact with the opening edges of the replenishing holes 57 in a direction from the hydraulic fluid to the replenishing holes 57 (refer to arrow A of FIG. 6). At this time, the second ends 54b of the seal members 54 are not bonded to the outer peripheral surface of the primary piston 52 and the outer peripheral surface of the secondary piston 53, as described above. Owing to this, the second ends 54b are elastically deformed in the way of being wound to the replenishing holes 57 (refer to FIG. 7).

Elastically deforming the seal members 54 brings the interior space 70 of the housing 51 into communication with the replenishing holes 57, 57, to allow the air stagnated in the interior space 70 to flow, along with the hydraulic fluid, from the replenishing holes 57, 57 to the interior space 80 of the reservoir tank 16 (refer to arrow B of FIG. 7). At this time, the flowing hydraulic fluid is guided to the inclination 57a and easily flows to the reservoir tank 16. This is because the front edge out of the opening edge on the inner periphery of each replenishing hole 57 is the inclination 57a that deforms forward from the outer periphery to the inner periphery of the peripheral surface 51a in the master cylinder 15. The air flowing, along with the hydraulic fluid, to the reservoir tank 16 is bled out of the brake device 1 via the reservoir tank 16.

When the seal members 54 are elastically deformed to communicate the interior space 70 of the housing 51 with the interior space 80 of the reservoir tank 16, the hydraulic pressure of the hydraulic fluid in the first hydraulic pressure chamber 71 gradually falls to weaken the force acting on the second ends 54b from the hydraulic fluid. Therefore, the seal members 54 are elastically restored to the state in which the second ends 54b contact the opening ends of the replenishing holes 57, and the replenishing holes 57 are closed again by the seal members 54.

In the brake device 1, the whole of the seal members 54, except for the second ends 54b, are bonded to the outer peripheral surfaces of the primary piston 52 and the secondary piston 53, as described above. As a result, the hydraulic fluid flowing in the first hydraulic pressure chamber 71 and the second hydraulic pressure chamber 72 enables the seal members 54 to be elastically deformed in the direction in which the second ends 54b separate from the outer peripheral surfaces of the primary piston 52 and the secondary piston 53.

Therefore, the air flowing into the master cylinder 15 can be delivered to the reservoir tank 16 without a dedicated member to switch the state of communication between the interior space 70 of the housing 51 and the interior space 80 of the reservoir tank 16. In addition, the number of members can be reduced, while the air flowing into the master cylinder 15 can be automatically bled to the reservoir tank 16.

The air may remain partially in the interior space 70 of the housing 51 without flowing to the reservoir tank 16. In this case, if the primary piston 52 is moved forward from the first position to the second direction, the residual air can be ejected outside the brake device 1, along with the hydraulic fluid, via the bleeder provided in each braking mechanism 20.

In the brake device 1, making the hydraulic pressure of the hydraulic fluid in the first hydraulic pressure chamber 71 and the second hydraulic pressure chamber 72 the negative pressure enables the air generated in the hydraulic pressure circuit 30 and the braking mechanisms 20 to flow, along with the hydraulic fluid, from the braking mechanisms 20 side to the master cylinder 15, as described above.

Therefore, in the brake device 1, the air can flow to the master cylinder 15 using the members necessary for the vehicle 100 in advance without using large-scale external machinery such as a vacuum pump. In addition, it is possible to sufficiently bleed the air with simple configurations and ensure a good operation state of the brake device 1.

Furthermore, in the brake device 1, the primary piston 52 is desirably moved from the second position to the third position in a state in which the pressure valves 36 and the pressure valves 37 are closed and the bypass valves 35 are opened under the control of the controller 13. The pressure valves 36 and the pressure valves 37 are also desirably switched to the opened state in the state in which the primary piston 52 is moved to the third position.

Through such control, when the interior space 70 of the housing 51 is put under negative pressure, the hydraulic pressure of the hydraulic fluid present in parts upstream of the pressure valves 36 and the pressure valves 37 in the first circuit 30a and the second circuit 30b is made the negative pressure.

In this state, the pressure valves 36 and the pressure valves 37 are switched to the opened state by the controller 13. Compared with a case where the primary piston 52 and the secondary piston 53 are moved to the third position with the pressure valves 36 and the pressure valves 37 remaining opened, the flow rate of the hydraulic fluid increases. This enables the air to flow more easily in the brake device 1, and it is possible to bleed the air from the brake device 1 more reliably.

It is described above, by way of example, that both the pressure valves 36 and the pressure valves 37 are switched from the closed state to the opened state by the controller 13 in the state in which the primary piston 52 is moved to the third position. As another example, the pressure valves 37 may be switched to the closed state, and the pressure valves 36 may be switched to the opened state in the state in which the primary piston 52 is moved to the third position.

Through such control, the air is bled in a hydraulic fluid passage from the braking mechanism 20 provided at the left rear wheel RL via the third hydraulic line L3. The hydraulic fluid does not flow from the braking mechanism 20 provided at the right front wheel FR in parts of the fourth hydraulic line L4 downstream of the pressure valve 37, and air bleeding is not performed.

Moreover, in the brake device 1, as many braking mechanisms 20 as the wheels (left front wheel FL, right front wheel FR, left rear wheel RL, and right rear wheel RR) are provided. The pressure valves 36 and the pressure valves 37 are provided in the third hydraulic line L3 and the fourth hydraulic line L4, which are the wheel-specific hydraulic lines, respectively. The controller 13 switches the pressure valves 36 and the pressure valves 37 into the opened/closed state independently. This enables a flow state of the hydraulic fluid to be switched per wheel-specific hydraulic line and a length of the passage through which the hydraulic fluid flows in the hydraulic pressure circuit 30 to be set to any size. Therefore, the negative pressure generated in the interior space 70 of the housing 51 can help the hydraulic fluid flow efficiently, and the air can be bled efficiently from the brake device 1.

Furthermore, the brake device 1 includes the hydraulic pressure pumps 32 for the hydraulic fluid to flow under the control of the controller 13 during the hydraulic pressure control, such as the ABS control or the ESP control. In the state in which the interior space 70 of the housing 51 is put under negative pressure and in which the hydraulic fluid flows from the braking mechanisms 20 to the master cylinder 15, the hydraulic pressure pumps 32 are actuated in the direction of assisting in the flow of the hydraulic fluid. This can further increase the flow rate of the flowing hydraulic fluid. Therefore, it is possible to increase the flow rate of the hydraulic fluid using the member provided in the brake device 1 in advance, make it easier for the air to flow by the hydraulic fluid in the brake device 1, and bleed the air from the brake device 1 more reliably.

Moreover, in the brake device 1, the gap between the primary piston 52 and the housing 51 and that between the secondary piston 53 and the housing 51 are sealed by the seal members 54 and the cup seals 59. As a result, while the primary piston 52 and the secondary piston 53 are moved, at least one of each seal member 54 or each cup seal 59 maintain the state in which the first hydraulic pressure chamber 71 and the second hydraulic pressure chamber 72 are hermetically closed. Therefore, highly hermetically closed states can be ensured between the housing 51 and the primary piston 52 and between the housing 51 and the secondary piston 53 irrespective of the moving positions of the primary piston 52 and the secondary piston 53. Thus, an appropriate hydraulic pressure of the hydraulic fluid can be ensured in the interior space 70 of the housing 51.

Furthermore, the first ends 54a of the seal members 54 contact the opening edges of the replenishing holes 57 in the state in which the primary piston 52 and the secondary piston 53 are moved to the second positions. The second ends 54b of the seal members 54 contact the opening edges of the replenishing holes 57 in the state in which the primary piston 52 and the secondary piston 53 are moved to the third positions. This can make the shortest the seal members 54 in a moving direction of the primary piston 52 and the secondary piston 53. Therefore, the appropriate hydraulic pressure of the hydraulic fluid can be ensured in the interior space 70 of the housing 51 without entailing a significant increase in manufacturing cost.

It is described above that the master cylinder 15 transforms the pedal force of the brake pedal 11 into the hydraulic pressure of the hydraulic fluid and that each braking mechanism 20 brakes the wheel by transforming the hydraulic pressure into the braking force. However, the brake device 1 may not necessarily include the brake pedal 11, and the braking force may be generated on each wheel of the vehicle 100 from the hydraulic pressure from the master cylinder 15. For example, the vehicle 100 may be a self-driving vehicle, and an instruction of the braking force could be issued to the master cylinder 15 by an element other than the brake pedal 11.

1. A brake device comprising:
a master cylinder;
a braking mechanism configured to brake a wheel of a vehicle by a braking force;
a hydraulic pressure circuit that couples the master cylinder to the braking mechanism; and
a reservoir tank configured to store a hydraulic fluid of the master cylinder, wherein
the master cylinder comprises:
a housing having
an interior space serving as a hydraulic pressure chamber, and
a replenishing hole communicating with the reservoir tank;
a piston configured to change a hydraulic pressure of the hydraulic fluid in the hydraulic pressure chamber by being moved with respect to the housing; and
a seal member configured to seal a gap between the housing and the piston by being moved along with the piston,
a first position, a second position, and a third position are positioned side by side in sequence as moving positions of the piston in a moving direction of the piston,
the replenishing hole communicates with the hydraulic pressure chamber when the piston is at the first position,
the seal member closes the replenishing hole when the piston is at the second position, and
the hydraulic pressure of the hydraulic fluid in the hydraulic pressure chamber is made a negative pressure in a state in which the seal member closes the replenishing hole when the piston is at the third position.

2. The brake device according to claim 1, wherein
a cup seal that seals the gap between the housing and the piston is attached to the housing.

3. The brake device according to claim 1, wherein
a direction in which the piston is moved from the first position to the third position is referred to as a first moving direction,
a direction in which the piston is moved from the third position to the first position is referred to as a second moving direction,
an end of the seal member on a side of the first moving direction is referred to as a first end,
an end of the seal member on a side of the second moving direction is referred to as a second end,
the first end contacts an opening edge of the replenishing hole when the piston being at the second position, and
the second end contacts the opening edge of the replenishing hole when the piston being at the third position.

4. The brake device according to claim 2, wherein
a direction in which the piston is moved from the first position to the third position is referred to as a first moving direction,
a direction in which the piston is moved from the third position to the first position is referred to as a second moving direction,
an end of the seal member on a side of the first moving direction is referred to as a first end,
an end of the seal member on a side of the second moving direction is referred to as a second end,
the first end contacts an opening edge of the replenishing hole when the piston being at the second position, and
the second end contacts the opening edge of the replenishing hole when the piston being at the third position.

5. The brake device according to claim 3, wherein
a whole of the seal member, except for the second end, is bonded to the piston.

6. The brake device according to claim 4, wherein
a whole of the seal member, except for the second end, is bonded to the piston.

7. The brake device according to claim 1, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.

8. The brake device according to claim 2, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.

9. The brake device according to claim 3, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.

10. The brake device according to claim 4, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.

11. The brake device according to claim 5, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.

12. The brake device according to claim 6, wherein
braking mechanisms each of which is the braking mechanism are provided as many as wheels of the vehicle,
the hydraulic pressure circuit comprises
a common hydraulic line coupled to the master cylinder, and
wheel-specific hydraulic lines branching off from the common hydraulic line and coupled respectively to the braking mechanisms,
pressure valves configured to be opened and closed are provided respectively in the wheel-specific hydraulic lines, and
each of the pressure valves is independently switched between an opened state and a closed state.
